(19) United States
(12) Patent Application Publication
(10) Pub. No.: US 2025/0189956 A1
(43) Pub. Date: Jun. 12, 2025

(54) COMPOSABLE AND MODULAR INTELLIGENT DIGITAL TWIN ARCHTECTURE FOR IOT OPERATIONS WITH COMPLEX EVENT PROCESSING OPTIMIZATION

(71) Applicant: HITACHI VANTARA LLC, Santa Clara, CA (US)

(72) Inventors: Hareesh Kumar Reddy KOMMEPALLI, Clifton Park, NY (US); Fnu AIN-UL-AISHA, Framingham, MA (US); Wei LIN, Plainsboro, NJ (US)

(21) Appl. No.: 18/843,426

(22) PCT Filed: Mar. 3, 2022
(86) PCT No.: PCT/US2022/018733

§ 371 Date: Sep. 3, 2024

(51) Int. Cl. G05B 19/418; G06Q 10/0639

(52) U.S. Cl. CPC G05B 19/41885; G06Q 10/06393

(57) ABSTRACT

Systems and methods described herein which can involve, for receipt of a composed digital twin, processing the composed digital twin through a policy core process that determines a policy for the digital twin; executing an asset core process that determines an asset hierarchy of physical assets represented by the digital twin based on metadata of the physical assets retrieved from a metadata database and the determined policy; executing a sensor core process that determines a sensor hierarchy to be associated with the asset hierarchy based on metadata of sensors retrieved from the metadata database of the sensors and the asset core process; executing an analytics solution core that determines analytics solutions for the physical assets; constructing pipelines to facilitate the analytics solutions across a policy core layer, asset core layer, sensor core layer, and analytics solution core layer of the digital twin; and executing the pipelines.

### BACKGROUND

### Field

The present disclosure is generally directed to Internet of Things (IoT) systems, and more specifically to intelligent solutions for Industrial Internet of Things (IIoT) applications to optimize the IoT operations by harnessing the power of data. Developing such solutions can involve complex event processing for IoT systems.

Related art digital twin-based solutions are attractive, but they are labor intensive and time consuming for effective deployment. Further, current digital twin-based solutions lack effective actionable business insights. There is a need for a composable on-demand digital twin architecture that is modular and scalable to customer needs. Solutions to standardize and productize digital twins along with actionable business insights can enable new smart products. The products can immensely benefit from composable digital twin solution powered by machine learning. Modular architectures allow for composability by putting together required modules to develop a solution. Scalable architectures allow for deployment on a single computer, or a cluster of computers or cloud environments. Further, the architectures that are heterogenous with different computational resources are needed.

In a related art implementation, there is a digital twin of a twinned physical system where one or more sensor values allow the system to monitor the condition of the selected portion of the twinned physical system and access the remaining useful life of the designated portion. Such related art implementations use analysis of the sensor values of a twinned physical system to further execute the optimization software and identify the optimal operational control of the twinned physical system and optimal operational practices. Such related art implementations enhance the working of the mission deployment, inspection and maintenance scheduling, and can be extended to other types of digital twins as well.

In another related art implementation, there is a hierarchical asset control system that relies on identification of an equipment list. Such a related art implementation works on determining the control path between the assets and identifies the constraints of the asset to allow a smart agent to control the asset. The related art control system is based on an intelligent asset-based templates that are populated after identifying the system bounds. The related art control system is equipped with a processor, that identifies the hierarchical arrangement of asset control relationships for a hierarchical asset control application by connecting each of the instantiated intelligent agents based on parent/child information.

### SUMMARY

Example implementations described herein are directed to an adaptive digital twin and its architecture that can be used to develop composable digital twins along with business policies that will facilitate quick development of adaptive machine learning based business solutions for complex events processing.

Example implementations described herein involve a composable modular architecture involving four modules: Analytics Solution Cores, Sensor Cores, Asset Cores, and Policy Cores. The inferencing and training pipelines will be composed on demand for complex event processing. Example implementations can compose multiple pipelines into a knowledge base of pipelines and execute only the pipelines based on events.

Analytics solution cores (ASC) represent a basic building block with machine learning algorithms that can be used for several vertical applications. An ASC store will store available algorithms in accordance with the desired implementation. Sensor cores make use of one or several analytics solution cores to provide actionable insights. Sensor cores can ingest real sensor data or virtual sensor data which is calculated by simple or complex algorithms/software in accordance with the desired implementation. An asset core represents the physical asset of interest and connects to the relevant sensor cores depending on the sensors associated with the specific asset.

The output of the asset core module will be ingested by the policy core to provide actionable insights that may use machine learning algorithms such as reinforcement learning or optimization algorithms. Further, the policy core manages creating the new pipelines with asset cores, sensor cores, and ASCs for training or inferencing while allocating compute resources to the new pipeline.

In example implementations, each of the layers (policy core, asset core, sensor core, ASC) can be multilevel. For example, the analytics solution core module can be multilevel with several analytics solution cores arranged in series. In another example, the digital twin asset can be multilevel with a parent machine with several sub-components. The data flow can be happening directly into the module or coming from the parent module depending on the desired implementation.

Aspects of the present disclosure can involve a method, which can include, for receipt of a composed digital twin, processing the composed digital twin through a policy core process that determines a policy for the digital twin; executing an asset core process that determines an asset hierarchy of physical assets represented by the digital twin based on metadata of the physical assets retrieved from a metadata database and the determined policy; executing a sensor core process that determines a sensor hierarchy to be associated with the asset hierarchy based on metadata of sensors retrieved from the metadata database of the sensors and the asset core process; executing an analytics solution core that determines analytics solutions for the physical assets based on the metadata database and the sensor core process; constructing pipelines to facilitate the analytics solutions across a policy core layer, asset core layer, sensor core layer, and analytics solution core layer of the digital twin; and executing the pipelines with computational resources to determine key performance indicator (KPI) values to be provided to an application programming interface (API).

Aspects of the present disclosure can involve a computer program, storing instructions which can include, for receipt of a composed digital twin, processing the composed digital twin through a policy core process that determines a policy for the digital twin; executing an asset core process that determines an asset hierarchy of physical assets represented by the digital twin based on metadata of the physical assets retrieved from a metadata database and the determined policy; executing a sensor core process that determines a sensor hierarchy to be associated with the asset hierarchy based on metadata of sensors retrieved from the metadata database of the sensors and the asset core process; executing an analytics solution core that determines analytics solutions for the physical assets based on the metadata database and the sensor core process; constructing pipelines to facilitate the analytics solutions across a policy core layer, asset core layer, sensor core layer, and analytics solution core layer of the digital twin; and executing the pipelines with computational resources to determine key performance indicator (KPI) values to be provided to an application programming interface (API). The computer program and the instructions can be stored on a non-transitory computer readable medium and executed by one or more processors.

Aspects of the present disclosure can involve a system, which can include, for receipt of a composed digital twin, means for processing the composed digital twin through a policy core process that determines a policy for the digital twin; means for executing an asset core process that determines an asset hierarchy of physical assets represented by the digital twin based on metadata of the physical assets retrieved from a metadata database and the determined policy; means for executing a sensor core process that determines a sensor hierarchy to be associated with the asset hierarchy based on metadata of sensors retrieved from the metadata database of the sensors and the asset core process; means for executing an analytics solution core that determines analytics solutions for the physical assets based on the metadata database and the sensor core process; means for constructing pipelines to facilitate the analytics solutions across a policy core layer, asset core layer, sensor core layer, and analytics solution core layer of the digital twin; and means for executing the pipelines with computational resources to determine key performance indicator (KPI) values to be provided to an application programming interface (API).

Aspects of the present disclosure can involve an apparatus, which can include a memory configured to store instructions and processor, configured to execute the stored instructions involving, for receipt of a composed digital twin, processing the composed digital twin through a policy core process that determines a policy for the digital twin; executing an asset core process that determines an asset hierarchy of physical assets represented by the digital twin based on metadata of the physical assets retrieved from a metadata database and the determined policy; executing a sensor core process that determines a sensor hierarchy to be associated with the asset hierarchy based on metadata of sensors retrieved from the metadata database of the sensors and the asset core process; executing an analytics solution core that determines analytics solutions for the physical assets based on the metadata database and the sensor core process; constructing pipelines to facilitate the analytics solutions across a policy core layer, asset core layer, sensor core layer, and analytics solution core layer of the digital twin; and executing the pipelines with computational resources to determine key performance indicator (KPI) values to be provided to an application programming interface (API).

Aspects of the present disclosure can include a system, which can involve a meta policy core actor configured to produce a policy for a digital twin; an asset core managing an asset core template configured to instantiate asset core actors in an asset hierarchy of physical assets represented by the digital twin based on metadata of the physical assets and the policy produced by the meta policy core actor; a sensor core managing a sensor core template to instantiate one or more sensor actors in a sensor hierarchy based on a metadata database and ingests physical or virtual sensor data from a database; an analytics solution core managing an analytics solution core template that instantiates one or more analytics solution core actors and trains or inferences analytic solutions based on metadata and sensor data received through the sensor hierarchy; and a pipeline constructor configured to construct pipelines to facilitate the analytics solutions across a policy core layer, asset core layer, sensor core layer, and analytics solution core layer of the digital twin and to construct additional pipelines or destruct certain pipelines during runtime execution of the pipelines.

### BRIEF DESCRIPTION OF DRAWINGS

FIG. 1 illustrates an example complex industrial facility with multiple assets in a hierarchy.

FIGS. 2(A) to 2(C) illustrate an example of a schematic of a generic process in manufacturing plant.

FIG. 3 is an illustration of the schematic of the four-layer architecture with policy cores, asset cores, sensor cores, and analytics solution cores, in accordance with an example implementation.

FIG. 4 illustrates an example of the four-layer architecture with (a) Policy cores; (b) Asset cores; (c) Sensor cores; (d) Analytics solution cores, in accordance with an example implementation.

FIG. 5 illustrates an example schematic of a policy core and its interactions with asset actors, computational environment, monitoring dashboard, business action, and IoT database, in accordance with an example implementation.

FIG. 6 illustrates an example flow of the architecture of the heuristic based engine for the meta policy actor, in accordance with an example implementation.

FIG. 7 illustrates an example flow of the architecture of the operation process of LSTM based engine for the meta policy actor, in accordance with an example implementation.

FIG. 8 illustrates an example schematic of components of an asset core template and a sensor core template, in accordance with an example implementation.

FIG. 9 illustrates an example schematic of components of an ASC core template, in accordance with an example implementation.

FIG. 10 illustrates an example of the solution operation process for pipeline execution, in accordance with an example implementation.

FIG. 11 illustrates an example of the solution operation process for monitoring with a single ASC, in accordance with an example implementation.

FIG. 12 illustrates an example of the solution operation process for the complex event processing in accordance with an example implementation.

FIG. 13 illustrates an example of an application scenario, in accordance with an example implementation.

FIGS. 14 to 16 illustrate an example of a manufacturing process problem which has three cases: Normal operation; Few robots not functioning on workstations; and One of the workstation not working respectively, in accordance with an example implementation.

FIG. 17 illustrates an example execution compute environment, in accordance with an example implementation.

FIG. 18 illustrates another example execution environment, in accordance with an example implementation.

FIG. 19 illustrates a system involving a plurality of assets networked to a management apparatus, in accordance with an example implementation.

FIG. 20 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Industrial systems have several components and a very complex hierarchy. Any damage or failure mode or event on one component can affect other components and subsequently the entire system. The effect of any event needs complex event processing to intelligently manage the IIoT systems. A digital twin based HoT management software system therefore needs to address such complex systems and events to effectively manage the entire system. Building such digital twin-based systems is very difficult due to the complexity of the software architecture and the types of models needed.

Different components of the system need different types of models. Such models could be purely data driven, purely physics based or some hybrid thereof. These models can be used to obtain actionable insights through a deep and intelligent understanding of the data by analyzing the event patterns, event filtering, event transformation or event hierarchies to determine the causality of the events.

Putting together a complex digital twin system with such diverse models is very complex. Additional complexity comes from diverse data needs for each of these component models with some needing streaming data from the component sensors, and the varied computational resources needed depending on the nature of the model. To enable such complex event processing, a modular, composable digital twin software architecture is needed to enable the processing, as well as to reduce the time to develop and time to market for different industrial customers. An iterative architecture is needed to model both static physical assets or dynamic process. Related art digital twin architectures focus on one or the other but not both. Further, architectures that encourage standardization and reduce time to market are needed to bring business value with high return on investment.

In a first example problem, there is an industrial facility with several assets and potential digital twin models for IIoT operation and complex event processing.

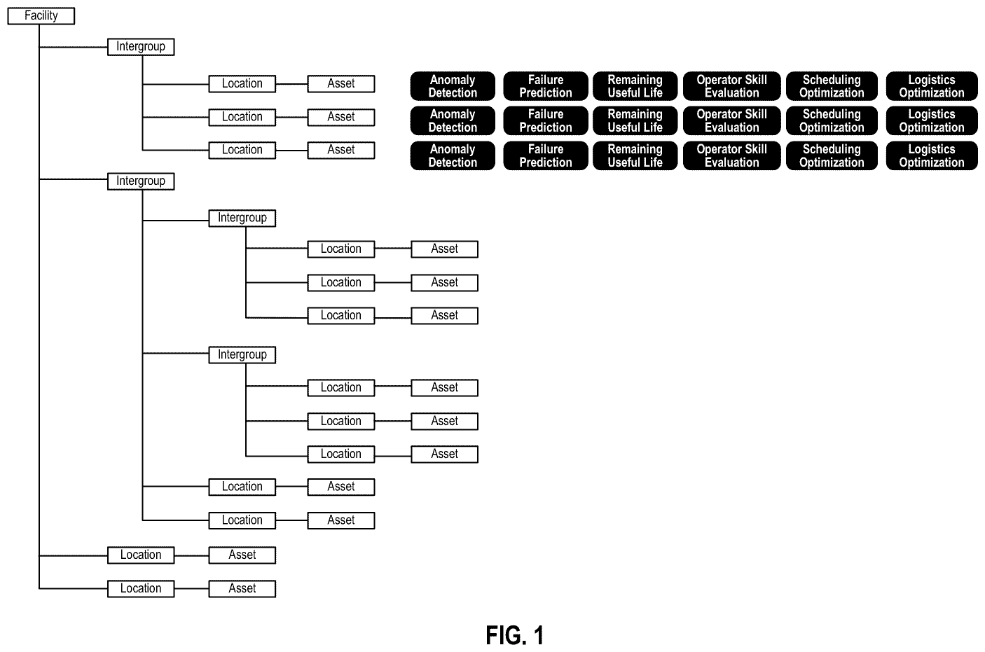

FIG. 1 illustrates an example complex industrial facility with multiple assets in a hierarchy. Each of the assets would benefit from processing by using different types of analytics algorithms such as anomaly detection, failure detection, and so on. The characteristics of this problem are as follows. The objective can be operational improvement and efficacy. The challenge can involve untangling both the web of data and the web of systems and processes. The value provided is that the modular and composable digital twin architecture could significantly reduce time to deployment of artificial intelligence-based solutions for IIoT applications. The types of models involved can involve the physical model, stochastic model, machine learning (ML) models and so on.

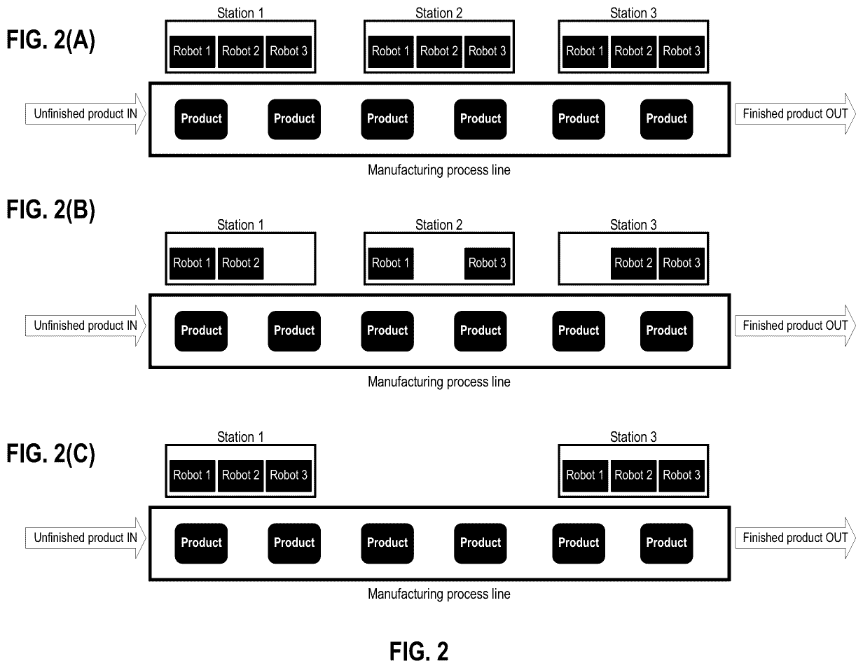

In a second example problem, there can be a manufacturing process problem. FIGS. 2(A) to 2(C) illustrate an example of a schematic of a generic process in manufacturing plant. Specifically, FIG. 2(A) illustrates an example of a normal operation, FIG. 2(B) illustrates an example of a few robots not working; and FIG. 2(C) illustrates an example of one station not working. During normal operation, all of the robots are working. However, during downtime there will be scenarios when certain robots are not working or certain stations are not working. The digital twin software system needs to dynamically adapt to such scenarios which is lacking in current architectures. In the example of FIGS. 2(A) to 2(C), there is a manufacturing plant with an unfinished product entering the assets on the left and moving towards the right. The plant has three stations 1, 2, 3 with three robots 1, 2, 3 each. For the modes of operation of the manufacturing plant, FIG. 2(A) illustrates the mode of operation in which all stations and robots are in working condition, FIG. 2(B) illustrates the mode of operation in which one robot in each station is not working due to an unplanned failure, and FIG. 2(C) illustrates the mode of operation in which one of the stations is completely offline.

In the example of FIGS. 2(A) to 2(C), the digital twin system should be able to monitor failure modes such as mechanical failure, performance reduction, and so on. In the event of failure of one or more robots or stations, the digital twin system should be able to compose a new solution to reflect the new set of assets. Further the digital twin should be able to handle complex event processing wherein a trigger of one event or failure mode should initiate additional processing for further confirmation of the failure modes and identify defects in related components.

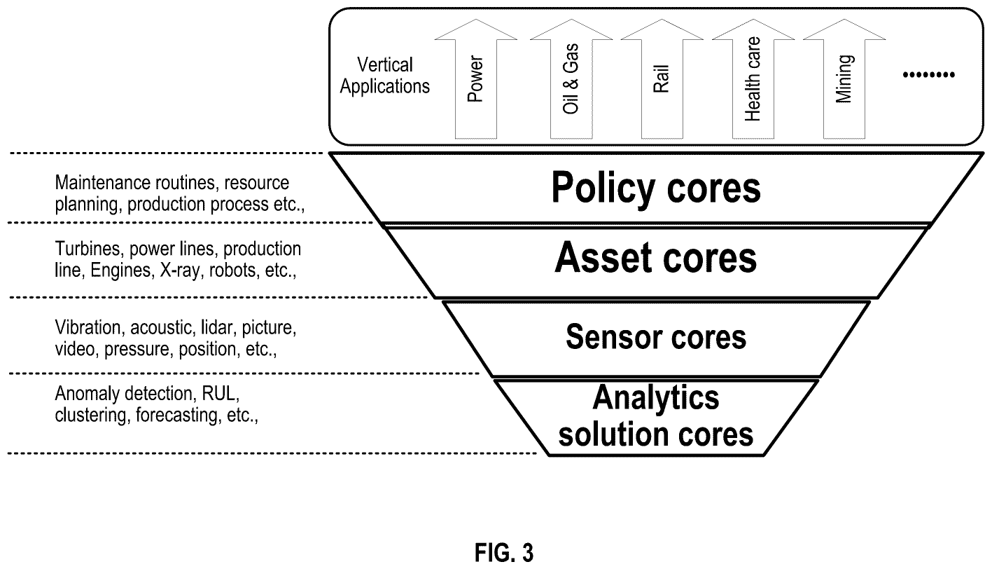

FIG. 3 is an illustration of the schematic of the four-layer architecture with policy cores, asset cores, sensor cores, and analytics solution cores, in accordance with an example implementation. Example implementations described herein create four layers of abstractions or modules that can both be developed independently and can interact or inherit each other to produce a modular architecture. The four layers involve policy cores, asset cores, sensor cores, and analytics solution cores. Together, the cores can be used to compose a solution for any vertical applications in power, oil and gas, rail, healthcare, mining, and so on in accordance with the desired implementation.

As will be described herein, a pipeline is defined as a series of policy cores, asset cores, sensor cores, and analytic solution cores put together to calculate a business outcome. The modular architecture in the present disclosure have the characteristics as follows.

Composable: The architecture should facilitate composing the computational pipelines to meet the changing requirements of physical assets in a static or dynamic fashion. Static means composing the digital twin pipeline before starting the software, and dynamic means changing the pipelines as needed while the digital twin software is executing.

Reusability: The cores need to be reusable. Reuse of cores facilitate a faster time to market and also greatly reduces the development cost.

Expandability: Each core is capable of expanding the capabilities by integrating and aligning with additional cores.

Combinability: The cores if needed, should be amenable to combine in series or parallel to build the pipeline. Such combinability can involve parallelism at the modular level, scalability with cloud, and enable required governance as per the business needs or government regulations (e.g., GDPR, and so on).

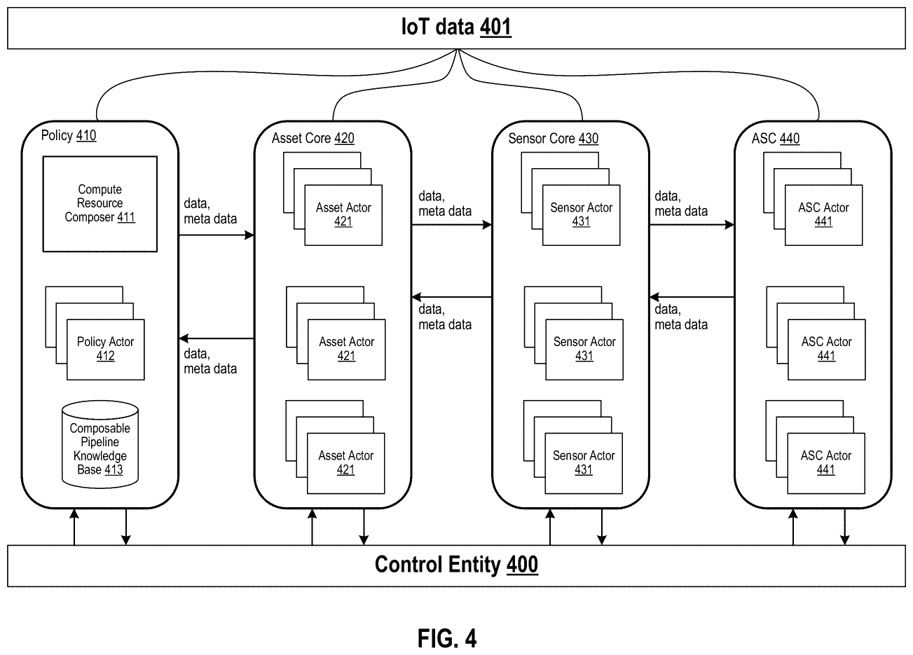

FIG. 4 illustrates the four-level architecture, in accordance with an example implementation. The control entity 400 enables four-layer orchestration for processing of IoT data 401. Depending on the desired implementation, the control entity can also be part of the policy core 410.

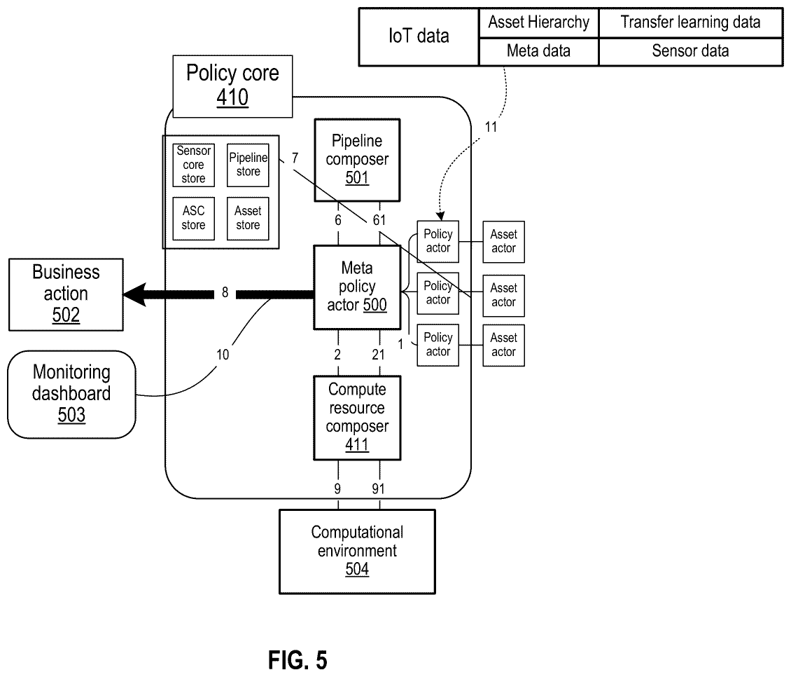

The policy core 410 is an intelligent engine that upon processing the results, determines possible next recommendations and shares the obtained insights on a dashboard for the user to gain additional insights and knowledge of the system. The policy core 410 also instantiates one or more policy actors 412 from use of a compute resource composer 411 and a composable pipeline knowledge base 413. Further details of the policy core 410 are provided with respect to FIG. 5.

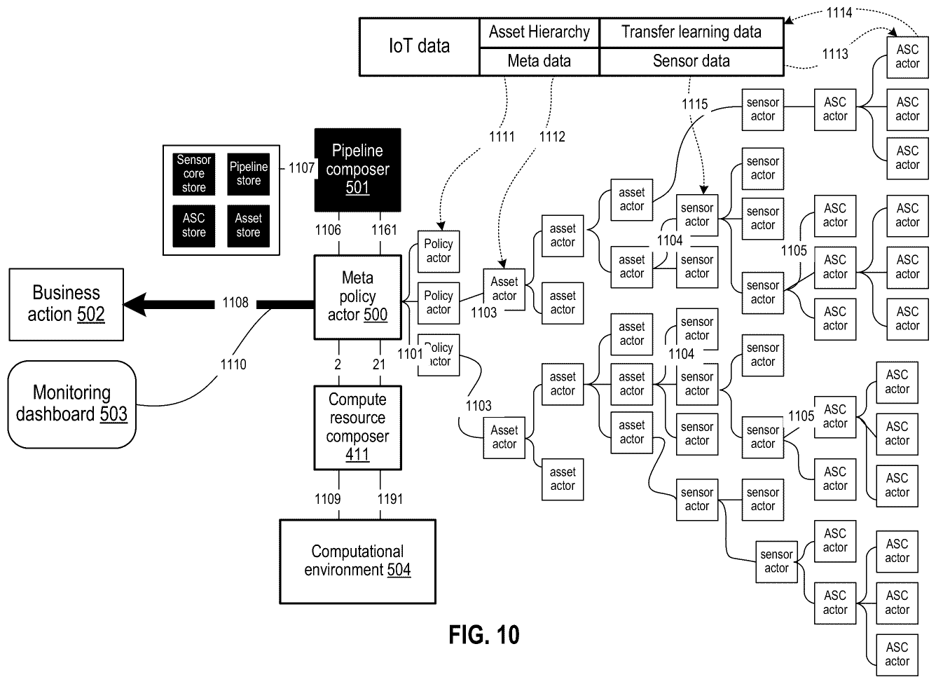

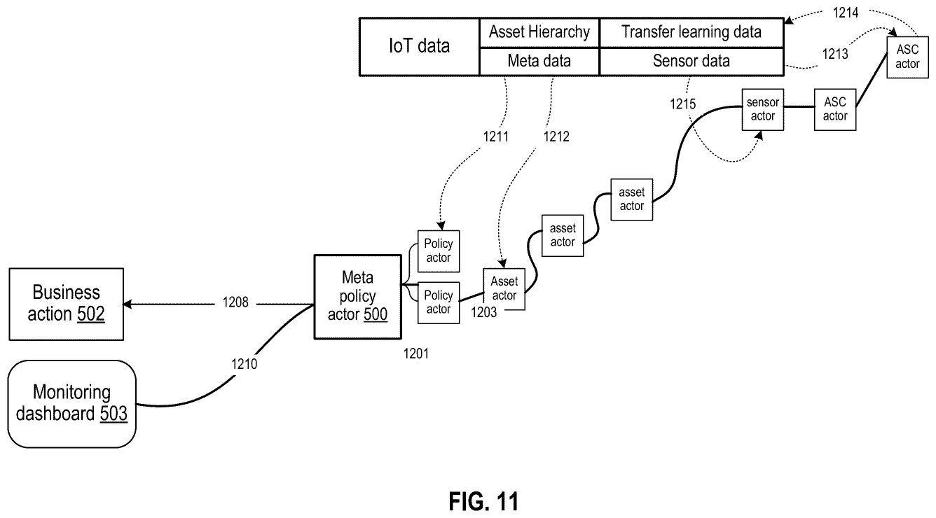

The asset core 420 instantiates one or more asset actors 421 to represent the asset hierarchy of the physical assets of the underlying system. Further details of the asset core 420 are provided with respect to FIG. 10(A). The sensor core 430 instantiates one or more sensor actors 431 to represent the sensor hierarchy derived from the asset hierarchy. Further details of the sensor core 430 are provided with respect to FIG. 10(B). The ASC 440 instantiates one or more ASC actors 441 to carry out the analytics solutions. Further details regarding the ASC 440 are provided with respect to FIG. 11.

FIG. 5 illustrates an example schematic of a policy core and its interactions with asset actors, computational environment, monitoring dashboard, business action, and IoT database, in accordance with an example implementation.

The structure of policy core 410 includes a meta policy actor 500 that interacts with other policy cores, pipeline composer 501, and a meta data store including information about sensor cores, pipeline, ASC, and assets. Meta policy actor 500 also interacts with asset actors, compute resources, business action application programming interface (API) 502, monitoring dashboard API 503, or operational control API.

Policy core 410 is capable of instantiating and executing new pipelines based on the observed events and outcomes. To start any new pipeline, the policy core 410 goes over a series of actions, which involves identifying the possible analytical solution cores and then identifying all the possible assets, data and meta data relevant to the new analytical pipeline. Policy core 410 is also aware of all the available resources (hardware, software and computational time) and calculates the optimal combination of the resources and computational power given the time constraints required for obtaining desired insights. Depending on the desired implementation, the policy core 410 can be multilevel. For example, the output of the alert optimizer can be sent to the business policies algorithm to provide an actionable insight.

Each policy core 410 can build and execute an analytical pipeline, which can involve asset core, sensor core, and ASC core. A meta policy core template is the standardized code base that can be re-used to instantiate asset actors in runtime. It can have multiple engines such as heuristic engine, deep learning-based reinforcement learning engine to make decisions for business insights, or additional pipeline generation in accordance with the desired implementation.

Depending on the desired implementation, meta policy actor 500 and policy actors can be multilevel. A meta policy actor 500 can be connected to other meta policy actors or policy actors. A policy actor can be connected to other one or several policy actors or asset actors. Further, a meta policy actor 500 can be connected to a pipeline composer 501 and to a computational resource composer 411.

The intelligence algorithms in the policy core include but not limited to heuristic based/deep learning-based reinforcement learning algorithms for prescribing business action or triggering build/execute new pipelines, and/or optimization algorithms to optimize a process parameter like maximize yield in a manufacturing process.

In the example of FIG. 5, the pipeline construction process can be as follows. At 1, the meta policy actor 500 monitors certain pipelines and determines if a new pipeline is needed for detection/prediction to further create business value. At 10, the meta policy actor 500 sends monitoring information to monitoring dashboard to provide users feedback of any events and get any user input regarding new pipeline as needed. At 6, the meta policy actor 500 sends meta data to construct a pipeline based on monitoring results and business need. At 61, the pipeline composer 501 sends the new pipeline metadata to meta policy actor 500. At 2, the meta policy actor 500 sends compute resources required based on data obtained from pipeline composer 501 as calculated using the IoT data store and ASC store data for a pipeline, and provides it to compute resource composer 411.

At 9, the compute resource composer 411 sends relevant information to the computational environment 504 for the creation or confirmation of the desired environment. At 91, the computational environment 504 sends the confirmation of availability of the computational environment that was desired. At 21, the compute resource composer 411 send the confirmation of the compute resources to meta policy actor 500.

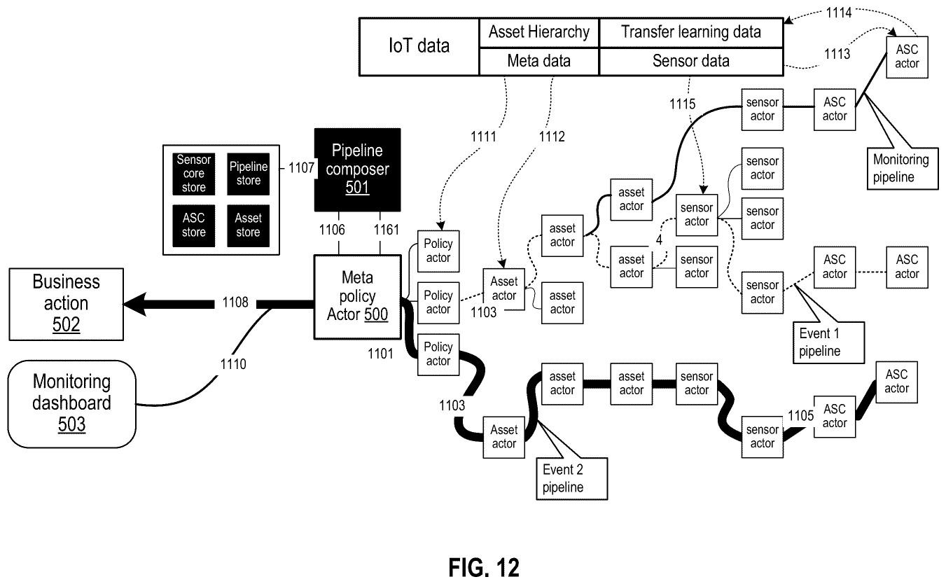

At 11, the meta policy actor 500 spins a new policy actor to build a new pipeline, further details of which are provided in FIG. 12. As shown in FIG. 12, at 3, the meta policy actor 500 constructs a new pipeline using meta data from pipeline composer 501, meta policy actor 500 and IoT data consisting of asset actors, sensor cores, and ASC actors as needed. The pipelines uses a directed acyclic graph (DAG) architecture that can be implemented with parallel distributed computing tools. At 12, the asset actor gathers asset hierarchy information from the IoT asset hierarchy store to create the pipeline.

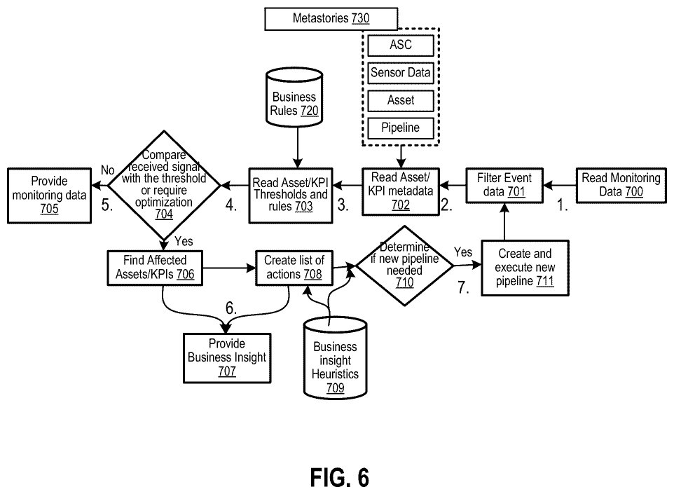

FIG. 6 illustrates an example flow of the architecture of the heuristic based engine for the meta policy actor, in accordance with an example implementation. At first, the meta policy actor 500 constantly monitors an asset pipeline at 700 and filters the received signals and results as meaningful events at 701. Then, the filtered event and the metastore are used collectively to gain more insights about the event (e.g., what is the associated key performance indicator (KPI), or which asset contributes most to the signal) through reading the KPI/asset metadata 702. Once the assets and the associated KPIs are understood along with the signal at 703, the associated business rules 720 are captured. After which, the meta policy actor 500 evaluates if the signal was received and determines whether it is in the normal range or not, or if the KPI requires optimization at 704. Based on the evaluation, the next actions are identified, and the meta policy actor 500 provides the monitoring data at 705.

Subsequently at 706, the meta policy actor 500 continues to monitor the asset to gain further insights. Another possible outcome is to provide insights at 707 in conjunction with the list of affected assets and KPIs and the actions associated with them at 708. In another possible outcome, a determination 710 is made to create an optimized new pipeline at 711 with the help of the list of actions and the business heuristics at 709.

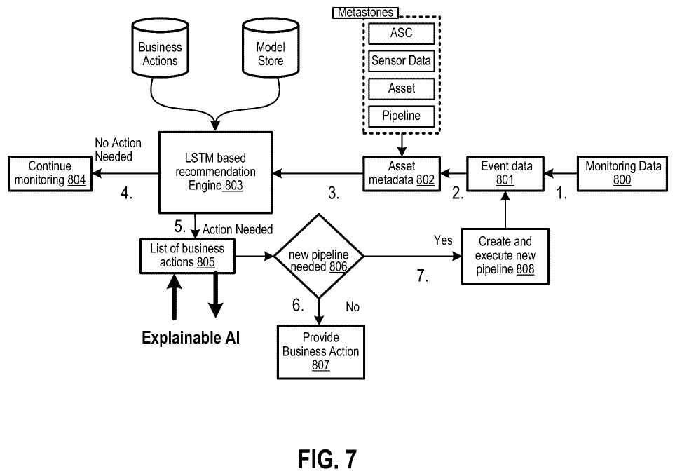

FIG. 7 illustrates an example flow of the architecture of the operation process of LSTM based engine for the meta policy actor, in accordance with an example implementation. In an example flow for the Long Short Term Memory (LSTM) Based Engine for meta policy actor 500, at first, the meta policy actor 500 constantly monitors an asset pipeline at 800 and filters the received signals and results as meaningful events at 801. Next, the filtered event and the metastore are used collectively at 802 to gain more insights about the event (e.g., what is the associated KPI, or which asset contributes most to the signal) by the LSTM based engine at 803. Further insights can also be gained from the signal with the help of a pre-trained neural network and the business actions. Then, the meta policy actor 500 can also continue to monitor the asset to gain further insights at 804, depending on the desired implementation. For further actions, the meta policy actor 500 makes use of the explainable AI to create a list of actions at 805 based on the insights gained through the neural network. Another possible outcome is to provide the business insights to the user with the help of possible actions for the business optimizations at 807 if it is determined that no extra pipeline is needed at 806, in accordance with the desired implementation. Further improvements to the system can be provided by running another pipeline at 808 if it is determined to be needed at 806.

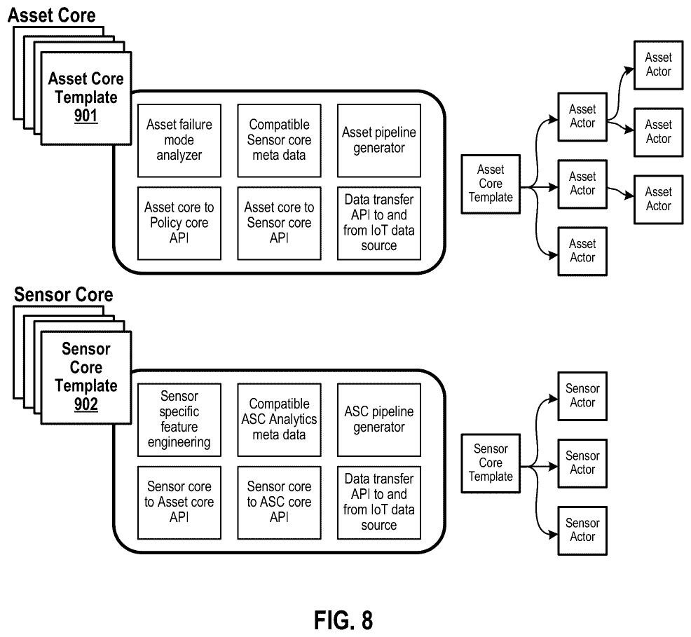

FIG. 8 illustrates an example schematic of components of an asset core template and a sensor core template, in accordance with an example implementation. An asset core template 901 is the standardized code base that can be re-used to instantiate asset actors in runtime. Asset actors can be multiple layers. An asset actor can be connected to one or more sensor actors, one or more other asset actors, and/or to a policy actor depending on the desired implementation. The template can include various libraries in accordance with the desired implementation, such as but not limited to an asset failure mode analyzer, compatible sensor core meta data, asset pipeline generator, asset core to policy core API, asset core to sensor core API, and data transfer API to/from IoT data source.

A sensor core template 902 is the standardized code base that can be re-used to instantiate sensor actors in runtime. Sensor core actors can be multiple layers. One sensor actor can be connected to one or more ASC actors, one or more other sensor actors, and/or to an asset actor depending on the desired implementation. The template can include various libraries in accordance with the desired implementation, such as but not limited to sensor specific feature engineering, compatible ASC analytics meta data, ASC pipeline generator, sensor core to asset core API, sensor core to ASC core API, and data transfer API to/from IoT data source.

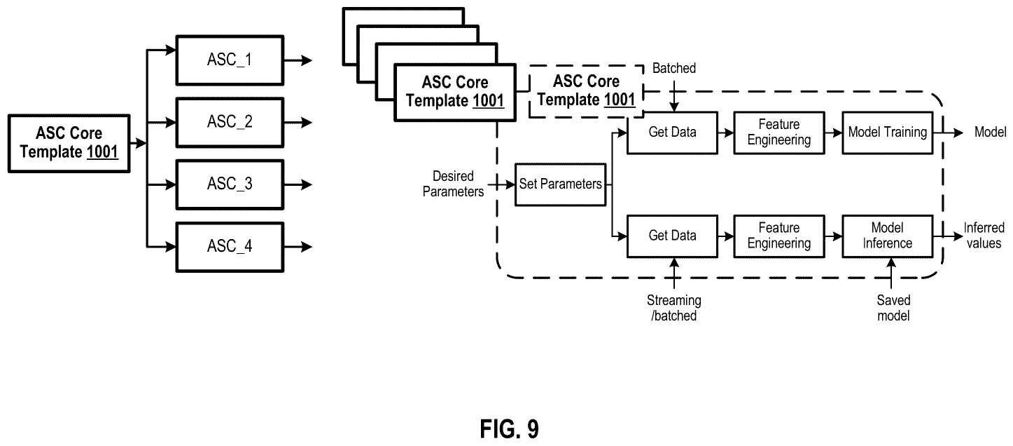

FIG. 9 illustrates an example schematic of components of an ASC core template, in accordance with an example implementation. An ASC core 1001 is like a class in objected oriented programming and has a blue print of the algorithm for that analytics solution. The ASC core class can contain several sub classes to read data, process data, perform feature engineering, training the model, and/or inferencing from the developed model. Further, the class can have appropriate flags to do training or inferencing depending on the meta data coming from the sensor core. While generating the pipeline, the policy actor retrieves the ASC core to generate the ASC actor by passing in metadata required to create the ASC actor.

FIG. 10 illustrates an example of the solution operation process for pipeline execution, in accordance with an example implementation. With respect to the pipeline execution process, at 1101, the meta policy actor 500 sends a message to the appropriate policy actor for execution. At 1103, the policy actor executes the asset actor pipeline. At 1104, the asset actor executes sensor actor as per the pipeline. At 1115, the sensor data is accessed by sensor actor depending on the ASC in the pipeline that is composed. At 1105, the sensor actor sends the data to ASC and executes the ASC actor. At 1113, the ASC actor receives operational information and other IoT data from IoT data store. At 1114, the ASC actor send any transfer learning related data to IoT store.

At 1105, the ASC actor computes and send the results to sensor core. At 1104, the sensor actor computes and sends result back to asset actors. At 1103, the asset actors aggregate and compute the result and send the events to policy actor. At 1101, the policy actor sends the event information to meta policy actor 500. At 1108, the meta policy actor 500 will send any action triggers to business action API 502 based on the algorithms being executed. At 1110, the meta policy actor 500 sends event information to a monitoring dashboard 503 for user consumption.

FIG. 11 illustrates an example of the solution operation process for monitoring with a single ASC, in accordance with an example implementation. For the monitoring process with a single ASC, the meta policy actor 500 would be executing one or several pipelines for monitoring the assets. The example of FIG. 11 illustrates an example of monitoring with one pipeline.

The processing and data flow for monitoring is as follows. At 1215, the sensor core receives asset sensor data regarding whether sensor data or virtual senor data is to be processed by ASC actors. At 1213, the ASC actor receives operational data from the IoT store. At 1205, the ASC actor sends the detection or prediction to the sensor core.

At 1204, the sensor core sends event information to the asset actor. At 1203, the asset actor sends event information to the policy actor. At 1210, the meta policy actor 500 sends monitoring information to the monitoring dashboard 503. At 1208, the meta policy actor 500 sends business actions 502 based on prebuilt algorithms.

FIG. 12 illustrates an example of the solution operation process for the complex event processing in accordance with an example implementation.

In an example of the event driven complex event processing, the systems monitor the assets using certain monitoring pipelines. Based on certain events, the meta policy actor 500 can spin additional pipelines during runtime to calculate to calculate additional parameters such as remaining useful life of the same component, health score of a related component and so on, to calculate and derive an actionable insight.

The event 1 pipeline (in dashed line) is in response to an event 1 that meta policy actor initiated to create to calculate additional parameters. In this case, the event 1 pipeline is for the same asset as the monitoring asset. The event 2 pipeline (in bold line) is triggered on a different asset based on an event on monitoring asset. Additionally, multiple pipelines can be triggered in parallel in response to the result of a monitoring alert or a combination of monitoring alert and previous event pipelines, depending on the desired implementation.

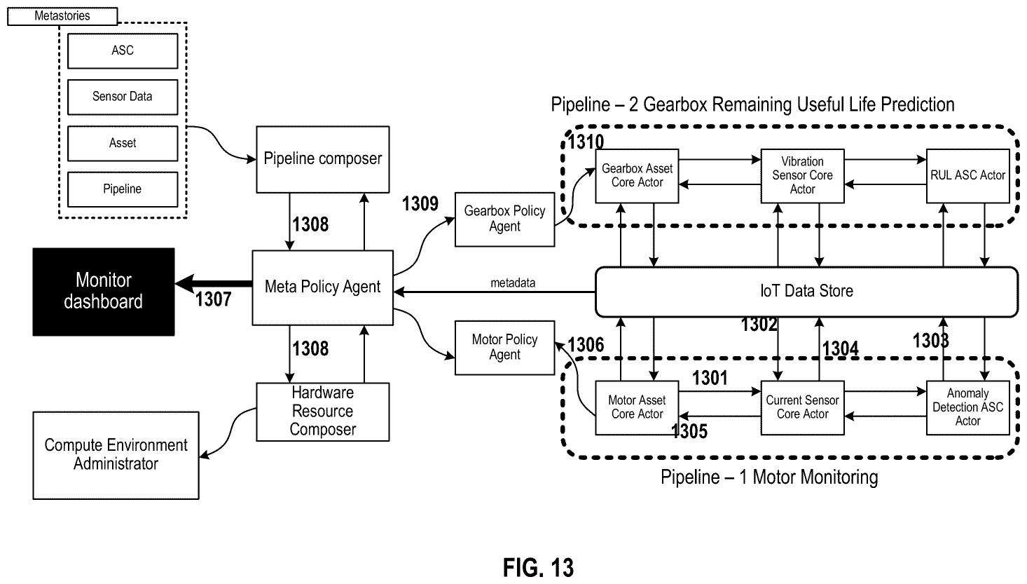

FIG. 13 illustrates an example of an application scenario, in accordance with an example implementation. In an example application scenario, at 1301, the monitoring asset core will send a request to sensor core to initiate the ASC pipeline to monitor the motor of an underlying system. The request can either be change based or time based. At 1302, the sensor core collects the meta data for the required data. and identifies and creates the correct data structure for the ASC relevant to the motor. At 1303, the ASC gathers the data from the IoT data store to ensure that the most updated data is used to run the ASC. Further, previously deployed models can be used for the transfer learning as applicable. After the run, ASC returns the insights to the IoT data store and to the sensor core. At 1304, the sensor core separates puts the meta data in the IoT data store for future use. At 1305, the sensor core shares the results calculated by the ASC with the asset actor. At 1306, the asset actor shares the results with the policy agent, which is responsible for understanding the results and identifies the next steps to be taken based on the results. At 1307, the policy agent shares the insights about the system on a monitoring dashboard. At 1308, the policy agent starts the creation of the new pipeline to calculate the remaining useful life for a gearbox, if recommended by the monitoring pipeline. To facilitate the creation, the policy agent looks at both the available hardware resources and the pipeline composer keeping the system resources in sight. At 1309, the new remaining useful life pipeline is triggered. At 1310, the predicting asset actor starts the pipeline by collecting information about the gearbox, and identifies if the results from the monitoring pipeline can be used as features for the prediction pipeline.

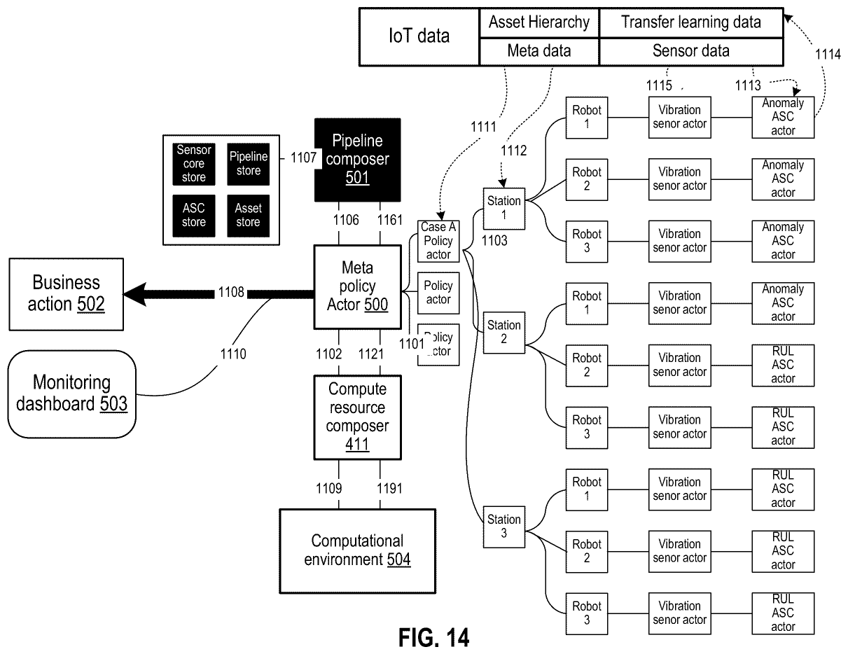

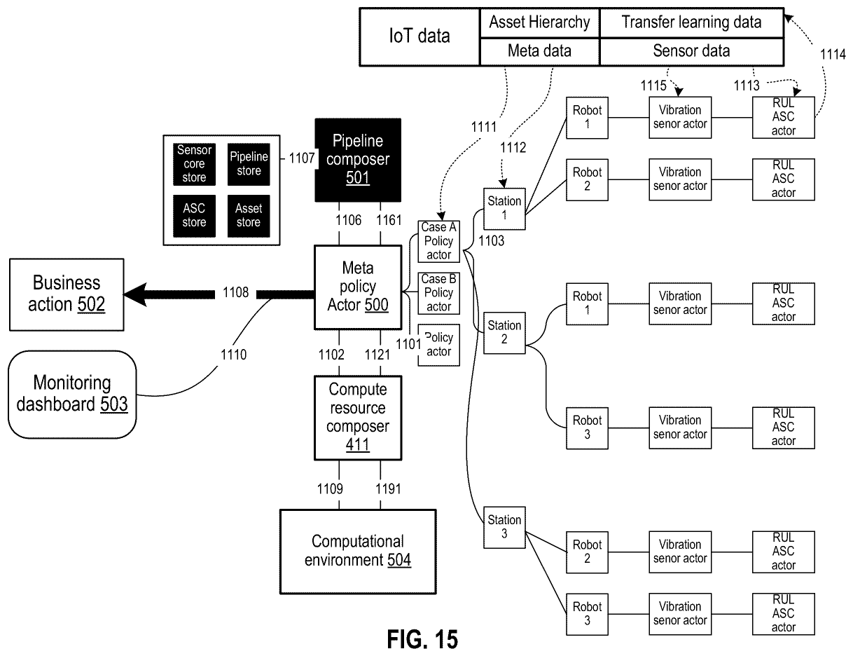

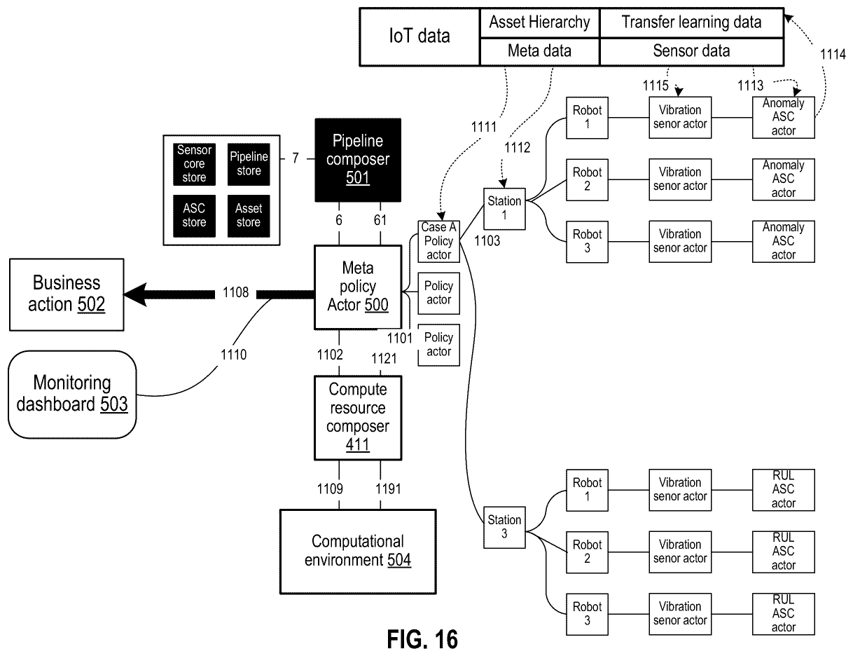

FIGS. 14 to 16 illustrate an example of a manufacturing process problem which has three cases: Normal operation; Few robots not functioning on workstations; and one of the workstation not working respectively, in accordance with an example implementation. The digital twin architecture should adjust for such scenarios and change the digital twin as per the latest functioning physical assets. The present disclosure addresses this problem by having the meta policy core dynamically change the pipelines depending on the scenarios as illustrated in FIGS. 14 to 16. The three types of digital twins for each case are shown in FIGS. 14 to 16.

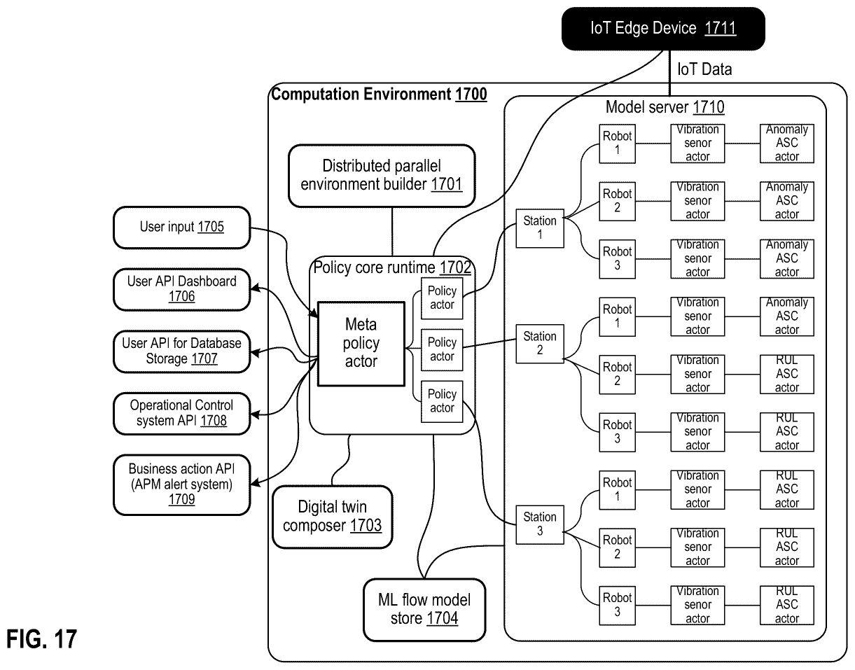

FIG. 17 illustrates an example execution compute environment, in accordance with an example implementation. In the example execution environment of FIG. 17, there is a computation environment 1700 which can be any compute environment (e.g., Kubernetes cluster) in accordance with the desired implementation.

Distributed parallel environment builder 1701 builds and manages the cluster as per instructions from policy core runtime 1702. Policy core runtime 1702 involves the central pieces of orchestration with meta policy actor and policy actors. Digital twin composer 1703 includes the composer, meta data store and templates for asset/sensor/ASC cores. ML flow model store 1704 is a model store with pre-developed models. User input API 1705 provides user input to meta policy store. User APIs provide APIs for visual dashboard 1706 and storage 1707. Operational control system API 1708 provides instructions to control the system for further action as per operational system algorithms. Business action AP 1709 is an Application Performance Management (APM) alert system for maintenance, repairs, and so on. The model server 1710 can run the models based on IoT data received from IoT devices 1711.

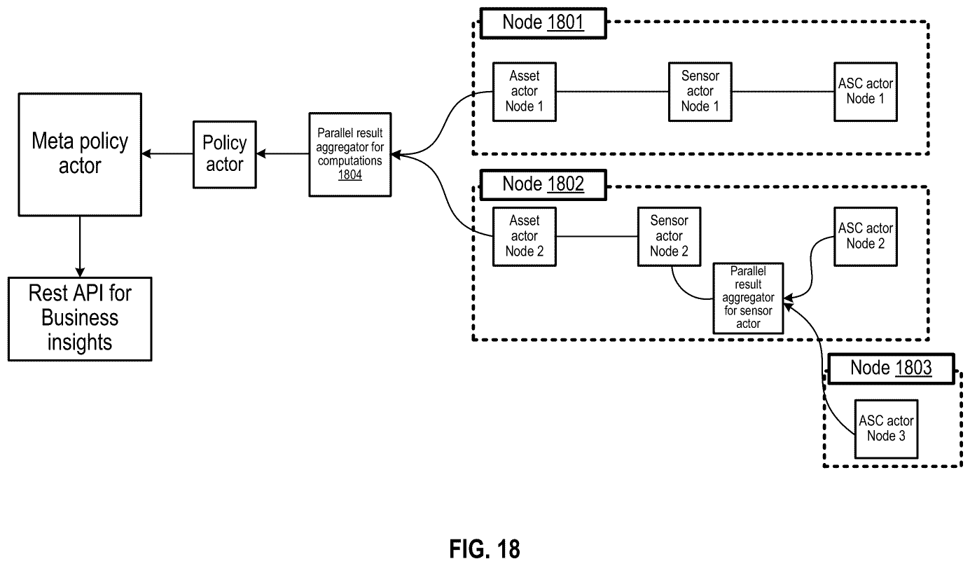

FIG. 18 illustrates another example execution environment, in accordance with an example implementation. In the example execution environment of FIG. 18, there is a parallel distributed solution involving multiple nodes 1801, 1802, 1803 instead of a model server. By using modular architectures, which allow parallel distributed computing, example implementations can make use of all the available resources of the compute environment and can execute multiple pipelines and resources in parallel, results of which can be aggregated by a parallel result aggregator for computations 1804. The template-based architecture for the cores ensure that each pipeline can be constructed and then processed independently, while making optimal use of the available computational resources.

Through the example implementations described herein, it is possible to facilitate complex event processing for IIoT systems, a standardization of the computational framework for asset cores to deliver business value, as well as flexibility of reuse of ASC's, sensor core, and asset cores to new assets and customers. Further, the example implementations described herein can facilitate the composition of new solutions from existing modules, scale the computation from single computer to multiple computers and to cloud infrastructure with minimal or no changes, provide standardization of analytics for quick deployment, significantly reduce the time to deploy a solution as well as enable non-experts to perform the deployment task.

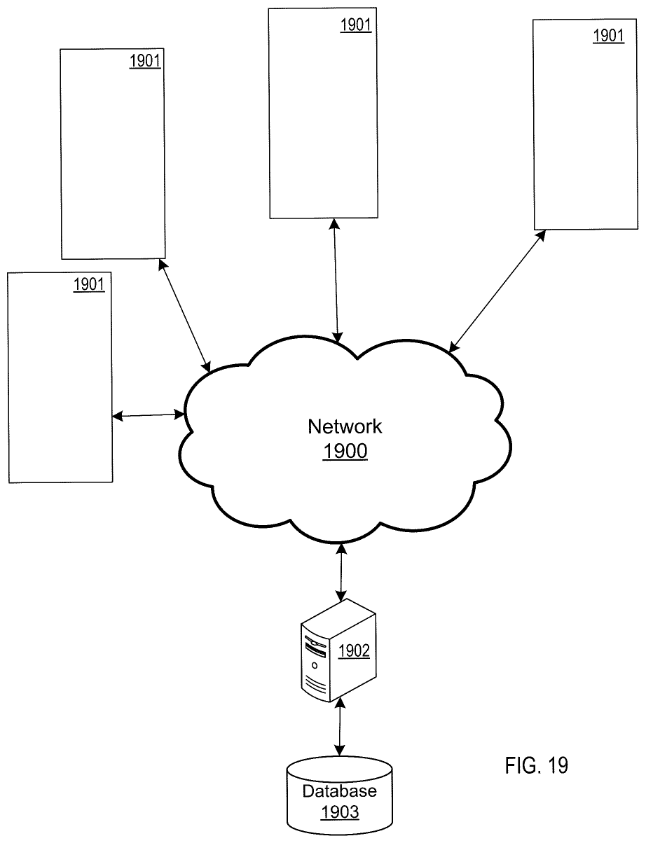

FIG. 19 illustrates a system involving a plurality of assets networked to a management apparatus, in accordance with an example implementation. One or more assets 1901 are communicatively coupled to a network 1900 (e.g., local area network (LAN), wide area network (WAN)) through the corresponding on-board computer or Internet of Things (IoT) device of the assets 1901, which is connected to a management apparatus 1902 that facilitates the models or digital twin of the assets. The management apparatus 1902 manages a database 1903, which contains historical data collected from the assets 1901 and also facilitates remote control to each of the assets 1901. In alternate example implementations, the data from the assets can be stored to a central repository or central database such as proprietary databases that intake data, or systems such as enterprise resource planning systems, and the management apparatus 1902 can access or retrieve the data from the central repository or central database. Asset 1901 can involve any physical system for use in a physical process such as an assembly line or production line, in accordance with the desired implementation, such as but not limited to air compressors, lathes, robotic arms, and so on in accordance with the desired implementation. The data provided from the sensors of such assets 1901 can serve as the data flows as described herein upon which analytics can be conducted.

The system of FIG. 19 can involve the underlying physical system upon which the physical process can be implemented. Depending on the desired implementation, the physical system and the physical process can be represented by the representations of the sensor core layer, the asset core layer, the ASC core layer, and the policy core layer as described herein. In an example implementation of a production line of a truck that can be used as the subject of the system of FIG. 19 and the represented digital twin, the physical process can involve two parts; the assets 1901 along with their hierarchy, and the physical process to assemble the truck.

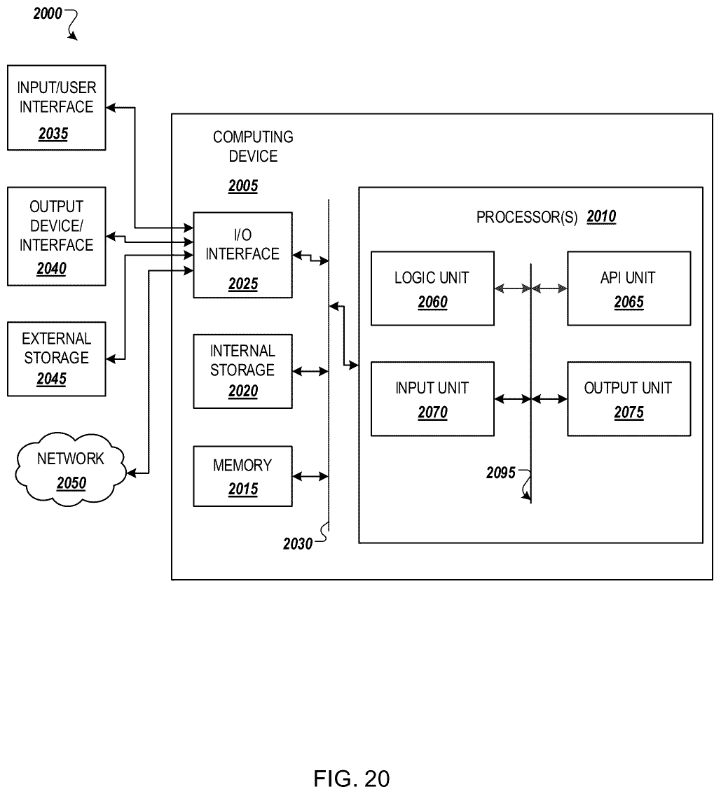

FIG. 20 illustrates an example computing environment with an example computer device suitable for use in some example implementations, such as a management apparatus 1902 as illustrated in FIG. 19, or as an on-board computer of an asset 1901. Computer device 2005 in computing environment 2000 can include one or more processing units, cores, or processors 2010, memory 2015 (e.g., RAM, ROM, and/or the like), internal storage 2020 (e.g., magnetic, optical, solid state storage, and/or organic), and/or I/O interface 2025, any of which can be coupled on a communication mechanism or bus 2030 for communicating information or embedded in the computer device 2005. I/O interface 2025 is also configured to receive images from cameras or provide images to projectors or displays, depending on the desired implementation.

Computer device 2005 can be communicatively coupled to input/user interface 2035 and output device/interface 2040. Either one or both of input/user interface 2035 and output device/interface 2040 can be a wired or wireless interface and can be detachable. Input/user interface 2035 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 2040 may include a display, television, monitor, printer, speaker, braille, or the like. In some example implementations, input/user interface 2035 and output device/interface 2040 can be embedded with or physically coupled to the computer device 2005. In other example implementations, other computer devices may function as or provide the functions of input/user interface 2035 and output device/interface 2040 for a computer device 2005.

Examples of computer device 2005 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 2005 can be communicatively coupled (e.g., via I/O interface 2025) to external storage 2045 and network 2050 for communicating with any number of networked components, devices, and systems, including one or more computer devices of the same or different configuration. Computer device 2005 or any connected computer device can be functioning as, providing services of, or referred to as a server, client, thin server, general machine, special-purpose machine, or another label.

I/O interface 2025 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 2000. Network 2050 can be any network or combination of networks (e.g., the Internet, local area network, wide area network, a telephonic network, a cellular network, satellite network, and the like).

Computer device 2005 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 2005 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 2010 can execute under any operating system (OS) (not shown), in a native or virtual environment. One or more applications can be deployed that include logic unit 2060, application programming interface (API) unit 2065, input unit 2070, output unit 2075, and inter-unit communication mechanism 2095 for the different units to communicate with each other, with the OS, and with other applications (not shown). The described units and elements can be varied in design, function, configuration, or implementation and are not limited to the descriptions provided. Processor(s) 2010 can be in the form of hardware processors such as central processing units (CPUs) or in a combination of hardware and software units.

In some example implementations, when information or an execution instruction is received by API unit 2065, it may be communicated to one or more other units (e.g., logic unit 2060, input unit 2070, output unit 2075). In some instances, logic unit 2060 may be configured to control the information flow among the units and direct the services provided by API unit 2065, input unit 2070, output unit 2075, in some example implementations described above. For example, the flow of one or more processes or implementations may be controlled by logic unit 2060 alone or in conjunction with API unit 2065. The input unit 2070 may be configured to obtain input for the calculations described in the example implementations, and the output unit 2075 may be configured to provide output based on the calculations described in example implementations.

Processor(s) 2010 can be configured to execute instructions or a method which can involve, for receipt of a composed digital twin, processing the composed digital twin through a policy core process that determines a policy for the digital twin; executing an asset core process that determines an asset hierarchy of physical assets represented by the digital twin based on metadata of the physical assets retrieved from a metadata database and the determined policy; executing a sensor core process that determines a sensor hierarchy to be associated with the asset hierarchy based on metadata of sensors retrieved from the metadata database of the sensors and the asset core process; executing an analytics solution core that determines analytics solutions for the physical assets based on the metadata database and the sensor core process; constructing pipelines to facilitate the analytics solutions across a policy core layer, asset core layer, sensor core layer, and analytics solution core layer of the digital twin; and executing the pipelines with computational resources to determine key performance indicator (KPI) values to be provided to an application programming interface (API) as illustrated in FIGS. 4 to 7.

Processor(s) 2010 can be configured to execute instructions or a method which can involve, for a detection of an event, triggering an automatic construction of additional pipelines based on the pipeline execution.

Processor(s) 2010 can be configured to execute instructions or a method wherein the executing the asset core process involves executing an asset core template based on the metadata of the physical assets and the determined policy to instantiate one or more asset core actors to form the asset hierarchy; connecting the one or more asset core actors to one or more policy core actors based on the determined policy; connecting the one or more asset core actors to one or more other asset core actors to build the asset hierarchy; and providing the KPI values to the one or more policy core actors.

Processor(s) 2010 can be configured to execute instructions or a method wherein the executing the sensor core process involves executing a sensor core template based on the metadata database to instantiate one or more sensor core actors as the sensor hierarchy; connecting the one or more sensor core actors to one or more asset core actors based on the asset hierarchy; connecting the one or more sensor core actors to one or more other sensor core actors to build the sensor dependency; feeding physical or virtual sensor data into the one or more sensor core actors from a database or from the one or more other sensor core actors; feeding metadata into the one or more sensor core actors from a metadata database or from the one or more asset core actors; and providing the KPI values to the one or more asset core actors.

Processor(s) 2010 can be configured to execute instructions or a method wherein the analytics solution core process involves executing an analytics solution core template on the metadata database to instantiate one or more analytics solution core actors; feeding physical or virtual sensor data from one or more sensor core actors; training or inferencing the analytics solutions based on metadata received through the sensor hierarchy; wherein the one or more analytics solution core actors write metadata to a database; wherein the KPI values are provided to the one or more sensor core actors.

Processor(s) 2010 can be configured to execute a method or instructions that further involve, for detection of one or more events associated with one or more assets from the asset hierarchy from monitoring the KPI values, generating additional pipelines during runtime execution of the pipelines for the one or more assets to calculate and derive an actionable insight for the one or more events. Depending on the desired implementation, the method or instructions can further facilitate functionality to do dynamic event generation, interpretation, and/or resolution for complex event processing. The event interaction each of pipeline can contribute and aggregate to final KPI. Depending on the size of the event, a sub pipeline can be generated to study the sub event. In addition, the predictive nature of the aggregate of the event information from pipelines executed can predict and remediate certain events before they occur in accordance with the desired implementation. Further, the optimization of event pipeline outcomes by the policy core layer could potentially serve for the prescriptive action on the asset once the event occurred.

Processor(s) 2010 can be configured to execute a method or instructions construct pipelines to facilitate the analytics solutions by generating a pipeline configuration through interaction with an infrastructure compiler based on available compute resources for the digital twin; and executing a set of pipelines from the pipeline configuration based on constraint to the available compute resources.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
for receipt of a composed digital twin:
processing the composed digital twin through a policy core process that determines a policy for the digital twin;
executing an asset core process that determines an asset hierarchy of physical assets represented by the digital twin based on metadata of the physical assets retrieved from a metadata database and the determined policy;
executing a sensor core process that determines a sensor hierarchy to be associated with the asset hierarchy based on metadata of sensors retrieved from the metadata database of the sensors and the asset core process;
executing an analytics solution core that determines analytics solutions for the physical assets based on the metadata database and the sensor core process;
constructing pipelines to facilitate the analytics solutions across a policy core layer, asset core layer, sensor core layer, and analytics solution core layer of the digital twin; and
executing the pipelines with computational resources to determine key performance indicator (KPI) values to be provided to an application programming interface (API).

2. The method of claim 1, further comprising, for a detection of an event, triggering an automatic construction of additional pipelines based on the pipeline execution.

3. The method of claim 1, wherein the executing the asset core process comprises:
executing an asset core template based on the metadata of the physical assets and the determined policy to instantiate one or more asset core actors to form the asset hierarchy;
connecting the one or more asset core actors to one or more policy core actors based on the determined policy;
connecting the one or more asset core actors to one or more other asset core actors to build the asset hierarchy; and
providing the KPI values to the one or more policy core actors.

4. The method of claim 1, wherein the executing the sensor core process comprises:
executing a sensor core template based on the metadata database to instantiate one or more sensor core actors as the sensor hierarchy;
connecting the one or more sensor core actors to one or more asset core actors based on the asset hierarchy;
connecting the one or more sensor core actors to one or more other sensor core actors to build the sensor dependency;
feeding physical or virtual sensor data into the one or more sensor core actors from a database or from the one or more other sensor core actors;
feeding metadata into the one or more sensor core actors from a metadata database or from the one or more asset core actors; and
providing the KPI values to the one or more asset core actors.

5. The method of claim 1, wherein the executing the analytics solution core process comprises:
executing an analytics solution core template on the metadata database to instantiate one or more analytics solution core actors;
feeding physical or virtual sensor data from one or more sensor core actors;
training or inferencing the analytics solutions based on metadata received through the sensor hierarchy;
wherein the one or more analytics solution core actors write metadata to a database;
wherein the KPI values are provided to the one or more sensor core actors.

6. The method of claim 1, further comprising, for detection of one or more events associated with one or more assets from the asset hierarchy from monitoring the KPI values, generating additional pipelines during runtime execution of the pipelines for the one or more assets to calculate and derive an actionable insight for the one or more events.

7. The method of claim 1, wherein the constructing pipelines to facilitate the analytics solutions comprises generating a pipeline configuration through interaction with an infrastructure compiler based on available compute resources for the digital twin; and
executing a set of pipelines from the pipeline configuration based on constraint to the available compute resources.

8. A non-transitory computer readable medium, storing instructions for executing a process, the instructions comprising:
for receipt of a composed digital twin:
processing the composed digital twin through a policy core process that determines a policy for the digital twin;
executing an asset core process that determines an asset hierarchy of physical assets represented by the digital twin based on metadata of the physical assets retrieved from a metadata database and the determined policy;
executing a sensor core process that determines a sensor hierarchy to be associated with the asset hierarchy based on metadata of sensors retrieved from the metadata database of the sensors and the asset core process;
executing an analytics solution core that determines analytics solutions for the physical assets based on the metadata database and the sensor core process;
constructing pipelines to facilitate the analytics solutions across a policy core layer, asset core layer, sensor core layer, and analytics solution core layer of the digital twin; and
executing the pipelines with computational resources to determine key performance indicator (KPI) values to be provided to an application programming interface (API).

9. The non-transitory computer readable medium of claim 8, the instructions further comprising, for a detection of an event, triggering an automatic construction of additional pipelines based on the pipeline execution.

10. The non-transitory computer readable medium of claim 8, wherein the executing the asset core process comprises:
executing an asset core template based on the metadata of the physical assets and the determined policy to instantiate one or more asset core actors to form the asset hierarchy;
connecting the one or more asset core actors to one or more policy core actors based on the determined policy;
connecting the one or more asset core actors to one or more other asset core actors to build the asset hierarchy; and
providing the KPI values to the one or more policy core actors.

11. The non-transitory computer readable medium of claim 8, wherein the executing the sensor core process comprises:
executing a sensor core template based on the metadata database to instantiate one or more sensor core actors as the sensor hierarchy;
connecting the one or more sensor core actors to one or more asset core actors based on the asset hierarchy;
connecting the one or more sensor core actors to one or more other sensor core actors to build the sensor dependency;
feeding physical or virtual sensor data into the one or more sensor core actors from a database or from the one or more other sensor core actors;
feeding metadata into the one or more sensor core actors from a metadata database or from the one or more asset core actors; and
providing the KPI values to the one or more asset core actors.

12. The non-transitory computer readable medium of claim 8, wherein the executing the analytics solution core process comprises:
executing an analytics solution core template on the metadata database to instantiate one or more analytics solution core actors;
feeding physical or virtual sensor data from one or more sensor core actors;
training or inferencing the analytics solutions based on metadata received through the sensor hierarchy;
wherein the one or more analytics solution core actors write metadata to a database;
wherein the KPI values are provided to the one or more sensor core actors.

13. The non-transitory computer readable medium of claim 8, further comprising for detection of one or more events associated with one or more assets from the asset hierarchy from monitoring the KPI values generating additional pipelines during runtime execution of the pipelines for the one or more assets to calculate and derive an actionable insight for the one or more events.

14. The non-transitory computer readable medium of claim 8, wherein the constructing pipelines to facilitate the analytics solutions comprises generating a pipeline configuration through interaction with an infrastructure compiler based on available compute resources for the digital twin; and
executing a set of pipelines from the pipeline configuration based on constraint to the available compute resources.

15. An apparatus, comprising:
a memory, configured to store instructions, and
a processor, configured to execute the instructions to execute a process comprising:
for receipt of a composed digital twin:
processing the composed digital twin through a policy core process that determines a policy for the digital twin;
executing an asset core process that determines an asset hierarchy of physical assets represented by the digital twin based on metadata of the physical assets retrieved from a metadata database and the determined policy;
executing a sensor core process that determines a sensor hierarchy to be associated with the asset hierarchy based on metadata of sensors retrieved from the metadata database of the sensors and the asset core process;
executing an analytics solution core that determines analytics solutions for the physical assets based on the metadata database and the sensor core process;
constructing pipelines to facilitate the analytics solutions across a policy core layer, asset core layer, sensor core layer, and analytics solution core layer of the digital twin; and
executing the pipelines with computational resources to determine key performance indicator (KPI) values to be provided to an application programming interface (API).
